(19) United States
(12) Patent Application Publication
(10) Pub. No.: US 2025/0308520 A1
(43) Pub. Date: Oct. 2, 2025

(54) NON-SPEECH SOUND CONTROL WITH A HEARABLE DEVICE

(71) Applicant: Sony Group Corporation, Tokyo (JP)

(72) Inventors: Brant Candelore, Poway, CA (US); James R. Milne, Ramona, CA (US); Justin Kenefick, San Diego, CA (US); William Clay, San Diego, CA (US)

(73) Assignee: Sony Group Corporation, Tokyo (JP)

(21) Appl. No.: 18/622,606

(22) Filed: Mar. 29, 2024

(51) Int. Cl. G10L 15/22; G06F 3/01; G06F 3/16

(52) U.S. Cl. CPC G10L 15/22; G06F 3/016; G06F 3/167; G10L 2015/226

(57) ABSTRACT

A non-speech sound control system is provided that enables user control of features associated with a hearable device by using non-speech sound control gestures. The system determines that a pattern of non-speech sound(s) by a user is a control gesture designated for a particular adjustment. Various sound factors are employed in this determination. A feedback indicator is provided back to the user describing the feature adjustment and enabling the user to ensure proper control is conducted. The user can then make additional or different adjustments or cancel the adjustment, if desired.

### CROSS REFERENCES TO RELATED APPLICATIONS

This application is related to the following application, U.S. Provisional Patent Application No. 63/571,967, entitled HEAD GESTURE-BASED CONTROL WITH A HEARABLE DEVICE, filed on Mar. 29, 2024 (020699-124700US/SYP352697US01), which is hereby incorporated by reference as if set forth in full in this application for all purposes.

### BACKGROUND

People often may non-speech sounds as they continue throughout a day. These non-speech sound can be the result of a bodily function, like a burping, breathing, and yawning. The non-speech sounds can also be made for pleasure, such as humming. At times, non-speech sounds can be a subtle way to communicate. For example, a clearing of the throat may be used to gain someone's attention. Such non-speech sounds can have different meanings according to culture, context, or definition.

Sound inputs for an electronic device can simplify use of the devices and enable a user to multitask by freeing hands. Typically, users can control electronic devices by pressing buttons, tapping or touching a portion of the device, opening an application on another device (e.g., a smart phone), or using voice assistance.

Hearable devices (interchangeably called “hearables”) include a variety of ear worn devices configured to alter the hearing abilities of the user, such as playing audio close to or into the ear (e.g., headphones, earbuds), blocking environmental audio (e.g., noise canceling devices), enhancing hearing of environmental audio (e.g., hearing aids), etc. Use of hearable devices have become common accessories to be worn and connected with other devices, such as smart phones, that have become constant fixtures for people. Simple, hands free control using hearables devices can be a significant convenient.

### SUMMARY

A non-speech sound control system (also called “control system”, “sound control system”, or “system”) is provided that enables user control of features associated with a hearable device by the user making non-speech sounds. The system determines that a non-speech sound by a user a sound gesture designated for a particular adjustment. Feedback is provided back to the user describing the feature adjustment and enabling the user to ensure proper control is carried out. The user can then make additional or different adjustments or cancel the adjustment, if desired.

A method is provided for using non-speech sounds to control one or more features associated with a hearable device. The method includes detecting a pattern of non-speech sounds by a user of the hearable device created by one or more of breath, nose, tongue, lips, and throat of the user. The pattern of non-speech sound is identified as a control gesture corresponding to a particular adjustment of the feature associated with the hearable device, by applying one or more sound factors. Based, at least in part, on identifying the control gesture, the feature associated with the hearable device is adjusted according to the particular adjustment. A feedback indicator is output to the user to describe the adjusting of the feature.

In some aspects, output from an artificial intelligence (AI) model may be received. The AI model may be trained, at least in part, on non-gesture sounds regularly made by the user and on the control gestures, to predict that the detected first pattern of non-speech sounds is the control gesture rather than a non-gesture sound.

In some implementation, the control gesture includes a distinct pattern of breathing that is different from regular breathing patterns of the user, wherein the distinct pattern includes at least one variation in a particular rate of inhale and/or exhale and includes a predefined hold time after exhale and/or after inhale

In still some implementations, the method also includes producing a tactile feedback by moving one or more hearable components proximal to a user ear, wherein the tactile feedback is associated with outputting of the feedback indicator.

At times, the feature that is adjusted includes audio beam focusing. The feedback indicator may include a notification of a section of a sound field that the audio beam focusing is directed at.

In some implementations, the method includes receiving another pattern of non-speech sounds. Context information associated with this other pattern of non-speech sounds may be gathered. One or more non-gesture sound factors may be applied to identify this other pattern of non-speech sounds as a non-gesture sound. The other pattern of non-speech sounds may be rejected for control of the feature.

In still some implementations, the method may include outputting an inquiry for user control. The pattern of non-speech sounds may be detected and found to be responsive to the inquiry.

In some implementations, the sound control system (also referred to as an apparatus) is provided, which is configured to adjust a feature associated with a hearable device. The sound control system has at least microphone to detect at least one non-speech sound of a user using the hearable device. The system also includes a hearable device including one or more processors and logic encoded in one or more non-transitory media for execution by the one or more processors and when executed operable to perform various operations as described above in terms of the method. In some implementations, the control system may include a sensor to detect the non-speech sound, capture images, and/or detect signals related to the non-speech sound.

In some implementations, a non-transitory computer-readable storage medium is provided which carries program instructions for adjusting features based on detected user non-speech sound control gestures. These instructions, when executed by one or more processors cause the one or more processors to perform operations as described above for the focusing method described above.

A further understanding of the nature and the advantages of particular embodiments disclosed herein may be realized by reference of the remaining portions of the specification and the attached drawings.

### BRIEF DESCRIPTION OF THE DRAWINGS

The disclosure is illustrated by way of example, and not by way of limitation in the figures in which like reference numerals are used to refer to similar elements.

FIG. 1 is a conceptual diagram illustrating an example setting in which various aspects of the sound control system can be implemented, in accordance with some implementations.

FIG. 2 is a conceptual diagram illustrating an example of the sound control system, which uses a control gesture to direct a size of a focus area, in accordance with some implementations.

FIG. 3 is a conceptual diagram illustrating an example of the sound control system that includes sound control of a feature by indicating a section of a field of view, in accordance with some implementations.

FIG. 4 a flow diagram of an example method for controlling a feature associated with a hearable using control gestures, in accordance with some implementations.

FIG. 5 is a flow diagram of various example method for controlling a feature associated with a hearable by focusing onto a section of a field of view, in accordance with some implementations.

FIG. 6 is a block diagram of components of the non-speech sound control system usable to implement in the processes of FIGS. 4 and 5, in accordance with some implementations.

### DETAILED DESCRIPTION OF EMBODIMENTS

The present non-speech sound control system enables a user to control a hearable device by making non-speech sounds in a detectable pattern without a need for inputs through touch or spoken word commands. The control gestures can be subtle, discrete, and easy for a user to carry out with little interruption to other tasks performed by the user. The control system is also beneficial for users who have restricted abilities to perform these other traditional types of control inputs. To ensure that adjustments are carried out as intended by the user, the control system can provide feedback of the adjustments to a feature associated with the hearable device. Other aspects may include an ability to filter out non-gesture sounds by the user to avoid or correct mistaken feature adjustments.

The sound control system employs sound factors to identify control gestures that direct an adjustment to be made to a feature associated with a hearable device. Sound factors may be sufficiently satisfied to determine that a non-speech sounds is a control gesture. The term “satisfying” in applying gesture or non-sound factors as used in this description, may include complying with a substantial number of factors, weighted sound factors (or non-gesture sound factors) or other processes to determine if factors are sufficiently satisfied. In some implementations, a threshold confidence value may be applied to determine whether adequate non-gesture factors are satisfied to accept or reject the non-speech sound as a control gesture.

The sound factors that define a pattern of non-speech sound may be specific for various control characteristics, such as sound factors indicating a type of feature associated with the hearable device, sound factors specific for a kind of adjustment, and sound factors for an amount (e.g., degree or level) of the adjustment. For example, the sound factors may specify a pattern of different non-speech sounds performed in a particular order within a predefined period of time to define a particular feature adjustment. Other sound factors to specify a gesture pattern may include a rate at which a sound is performed, a loudness or softness of the sound, a gap time in which no sound is made between sounds of the pattern, and the like. Often sound factors specify a combination of one or more non-speech sound instances, e.g., a non-speech sound repeated x times or a combination of two or more different and sequentially performed non-speech sounds.

Typically, the sound factors are significantly distinct to differentiate between various control gestures and to differentiate between a control gesture and non-gesture sound. For example, a single non-speech sound instance that is commonly or inadvertently made by the user may make it difficult to tell a control gesture from a random non-gesture sound. However, a single non-speech sound instance that is unusual for the user and/or performed in an unusual manner (such as a varied rate) may be a sufficient control gesture. Various other sound factors are possible.

The “non-speech sounds,” as applied in this description refers to various user non-lexical vocalizations, or wordless vocable sounds uttered by the user to communicate an intent to control an aspect of a feature associated with the hearable device. The utterance is not considered a word or term by typical the English language. As used in this description and the figures, the non-speech sounds can be expressed in writing or described by an onomatopoeia (word used to imitate the non-speech sound).

For example, the non-speech sound may be an interjection, such as “hmm” or other inarticulate utterance. The non-speech sound may also be sound associated with bodily functions, such as a sniffing, breathing, swallowing, or yawning. The non-speech sounds may be made by movement of the mouth other than to form English words, such as clicking tongue, smacking lips, gasp, slurp. The non-speech sounds may also be formed by the nose, such as sniffing, blowing out air, or by the back of the throat, such as forcing out air for a growl. Other non-speech sounds are possible that are associated with a user utterance to communicate intent to control the hearable device in a specific manner.

The non-speech sounds are often created by movement of breath, nose, tongue, lips, and/or throat. While in some cases there may be sound creation may be accompanied by some other secondary physical movement, such as jaw movement during a yawn, the source of the sound may be primarily from movement of the breath, nose, throat, lips, or tongue. The non-speech sound is typically not created by solely or primarily by the mouth or the jaw movement as in teeth tapping, grinding, or chewing, or mouth moving to form speech words. The non-speech sounds can be based on naturally made non-speech sounds, but performed in a different pattern. The non-speech sounds are often easy for a user to learn and remember and can be performed quickly.

Non-speech sounds that can form control gestures include, but are not limited to:

| Primary Source | Type 1 | Type 2 | Type 3 |
|---|---|---|---|
| Breath | Sigh | Yawn | Sucking |
| Nose | Sniff | Blow | Hum |
| Throat | Clearing | Swallow | Slurp |
| Tongue | Cluck | Stick out | |
| | | Wiggle | |
| Lips | Smack | Kiss | Whistle |

In some implementations, the non-speech sounds are primarily (as shown in the chart above) or secondarily (e.g., air through nose, throat, lips) made by movement of breath without formation of English words. Other non-speech sounds and sound patterns for control gestures are possible.

Control gestures that are primarily made by movement of breath may involve inhaling air, exhaling air, and/or hold time between inhale and/or exhale. The breathing may move through the nose, mouth, lips, or both. In some implementations, a control gesture may include a distinct pattern of breathing that differs from regular breathing patterns of a user going about a normal day or while at rest (i.e., eupnea breathing). The breath control gestures may be more forceful breaths such as diaphragmatic breathing or hyperpnea breathing, than typical at rest breathing or shallow (i.e., costal) breathing. A breathing hold time for a sound factor may be longer than a typical transition between inhale and exhale (and vice versa). The distinct breathing pattern may include variations in a particular rate of inhale and/or exhale, a predefined hold time after exhale and/or after inhale, and may specify use of nose and/or mouth for the breaths. At times, the breath may be accompanied by sound such as a “hiss” “hum” or “growl” with the nose, throat, or mouth. For example, a control gesture may include a pattern of a 5 second inhale, hold for 2 seconds and exhale for 5 second, repeated twice. In another example, a control gesture may include a pattern of rapid 1 second inhale with a nose and exhale for 2 second with a mouth.

The control gestures include patterns of sounds that may be distinguished from random non-control sounds (not intended for feature control) and comply with sound factors that define a particular feature control. The control gestures may include a combination of non-speech sounds to form a pattern of sounds with specific characteristics of the sounds (such as increase or decrease speed, sound held for a period of time, etc.). The user is instructed on the non-speech sound patterns required to request various feature adjustments. Over time, such non-speech sound patterns may become learned and easily performed by the user.

The hearable device of the non-speech sound control system can include a variety of types of hearing devices, such as earbuds, smart headphones, hearing aids, bone phones (bone conducting), and other ear directed devices configured to be worn (including insertable and implantable) that alter sounds heard by a user and may include various features that a user can control. Typically, the hearable device includes speakers that fit over or inside one or more ears. Some hearables may function solely for noise canceling for a user to block environmental sounds. Other hearables may be multifunctional to allow for multiple sensory enhancements, such as hearing aids for hearing corrections, audio listening devices that deliver audio content to the user, including smart headphones, smart earbuds, etc.

The hearable may include one hearing unit dedicated to one ear of the user, or may include a pair of hearing units (left and right) for a respective ear of the user. Processing circuitry and/or software components of a hearable device can capture, process, block, reduce, and/or amplify sounds that pass to the ear canal of the user. Other components of the hearable may be for securing the hearable in place when worn by the user, such as a band, cup, etc. Although specific examples of hearables are described, it should be understood that the non-speech sound control system may also apply to other hearable devices include components for identifying control gestures and initiating adjustments to features according to such gestures, as described below.

The “user” of the sound control system as applied in this description refers to a person who uses (e.g., wears) a hearable device that employs the sound control system. The user may operate the sound control system while the user goes about day to day activities with little disruption to those activities. Other hearables that do not employ the present non-speech sound control system, may require the user to use fingers to control a smart phone or touch a hearable. Some other hearables may require the user to use voice commands to control features and apply voice recognition algorithms in response to the voice commands.

Some hearables, such as hearing aids, are configured to enhance the hearing of the user who may not otherwise be able to sufficiently hear environmental noises. Non-audio based beamforming may be beneficial, for example, in cases that a sound source can be seen but not heard very well by the user, like a child talking with soft voice. A hearable that is configured to assist with hearing that does not employ the present sound control system may need a user to first hear a sound and then respond to the sound by controlling the hearable toward the source of the sound. This can cause the user to miss some of the sound in the process. The present control system, by contrast, enables the user to perform a simple non-speech sound in anticipation of a sound before the sound occurs. For example, the user may know the direction of a sound source, but may not hear the sound, and yet the user may adjust the system to focus on the anticipated sound.

Using various patterns of non-speech sounds can significantly increase the availability of controls, as there are numerous variations in non-speech sounds. The sound gestures can control types of features to be adjusted, types of adjustment that can be made on any given feature, and amount or strength of the adjustment. By comparison, the number of physical controls available for a device, such as buttons, may be constricted to physical space on the device. Physical controls may be also prone to accidental activation, for example, where a control button is inadvertently bumped. Accidentally changing a mode or setting can, for example, make a user lose a place in content that is playing.

The present non-speech sound control system addresses these problems with other systems and have additional benefits that will be apparent by this description.

In some implementations, the control gesture may be in response to an inquiry presented by the gesture control system. For example, the control system may output an inquiry as audio speech asking whether the user wants a particular feature adjustment or confirmation that the user intends to make a particular feature adjustment according to an identified control gesture. The control gesture responses may be non-speech sound(s) to indicate a positive response that is equivalent to a “yes” response or to indicate a negative response that is equivalent to a “no” response.

Other types of control gestures defined by various sound factors are possible. In some implementations, a combination of non-speech sounds may create a pattern recognized as a control gesture. For example, an audio beam forming control may focus audio elements onto a sound source, such as a person having a conversation in the horizontal and/or vertical planes of the microphone(s) in front of the user at different distances. In some implementations, the distance of the audio beam forming may be controlled by the control gestures, stepping between preset distances with each repeated non-speech sounds, such as 5, 10, 15, or 20 feet.

The features associated with the hearable device that may be adjusted using the control gestures may include various internal features with hardware and software integrated with the hearable device. In some implementations, the feature may be selected from the group of: operational setting, mode of operation, audio and/or visual content player, audio beam forming focus, calling interaction, and smart assistant operation, and other hearable device features adjustable by a user.

Some examples of hearable setting may include loudness or volume, graphic equalizer, bass, treble, noise cancelation function, etc. Some examples of hearable modes may include noise cancelation presets, ambient sound, front focus, tinnitus help, quick attention (e.g., turn down content player, call sounds, and the ringtone to allow ambient sound to be easily heard), speak-to-chat (e.g., pause or mute content player and capture the voice of a person user converses with on the microphones), priority on stable connection, priority on sound quality, etc.

Content player features enable changes to the audio content played through the speakers of the hearable device. Some examples of content player may include play, pause, skip to the beginning of a next or previous track, fast forward, fast reverse, rewind, stop, pause, select content, next content, volume increase or decrease of content, etc.

Beam forming may also be a feature controlled by the present gesture control system. Various audio elements, such as filtering and/or amplification may be adjusted such as to focus on a particular direction, directed to a section of a sound view or field of view, etc.

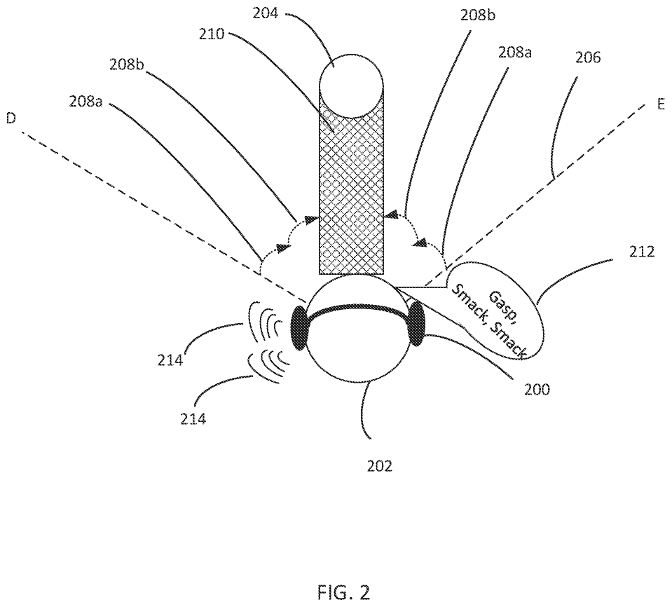

A sound field, similar to a field of view, includes the area surrounding the user in which a sound source is present. In some implementation, the width of a focus area may be adjusted using the control gestures, as described below in FIG. 2. For example, a focus area may be narrowed or widened relative to the user in the sound field of the user. The focus area distance from the user may also be adjusted, such as near focus area or far focus area from the user.

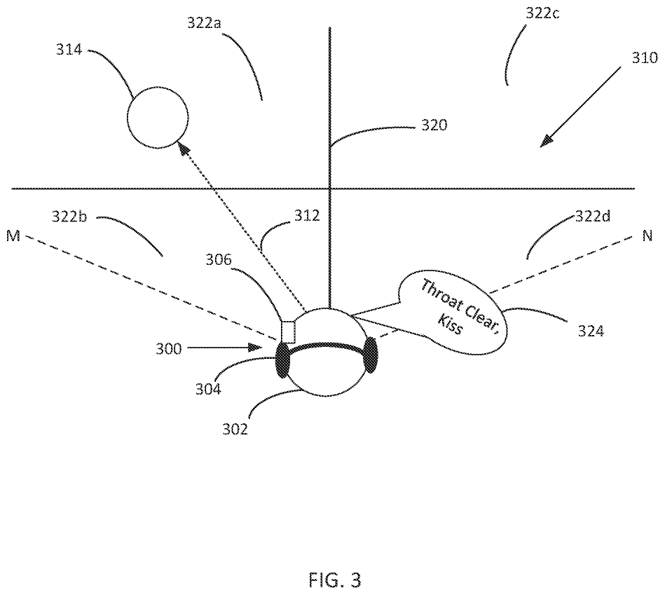

In some implementations, the user may perform a control gesture to indicate a target direction or section of the sound field or indicate a particular sound source onto which to focus the hearable device, as described below in FIG. 3. For example, the control system may recognize a pattern of non-speech sounds to indicate a target direction for the beam forming.

Some external features that may be controlled by the control gestures may include hardware or software located outside of the hearable device and associated with the hearable device by a communication connection with the hearable device. In some examples, the hearable device may control a phone or video call interactions with an external smart phone or other calling device, such as accepting a call, ending a call, adjusting volume of the call, etc. In some implementations, the hearable device may be used to control an operation of an external smart assistant (e.g., Alexa, Google Assistant) that is in electronic communication, e.g., via BLUETOOTH. To control such external features, the hearable device may identify the control gesture that corresponds with an aspect of the external device, e.g., smart assistant, and transmit control signals to a receiver of the external device to request the smart assistant make the adjustment to the feature.

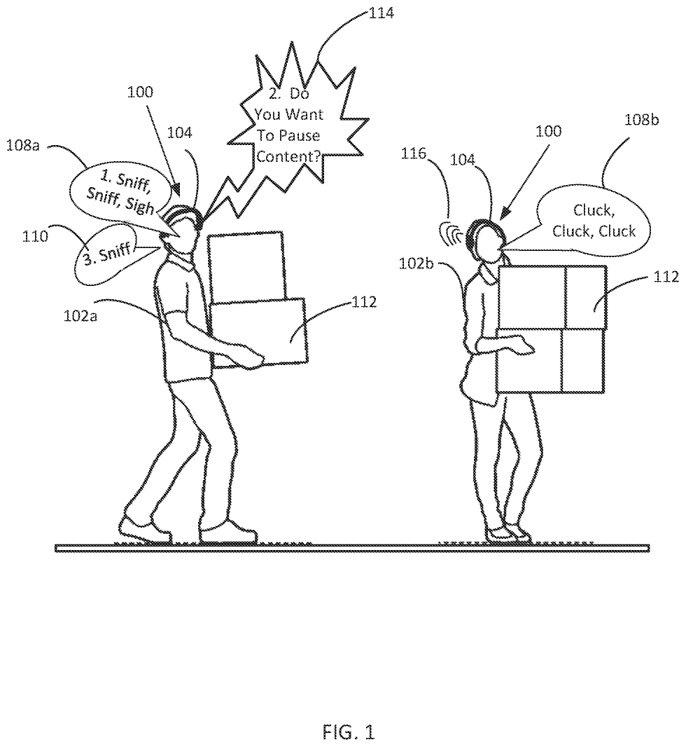

FIG. 1 is an illustrative example of the non-speech sound control system 100 employed by users 102a, 102b in which non-speech sound is detected and identified as control gestures. The non-speech sound control system 100 includes a hearable device 104 worn by users 102a, 102b enabling the users to occupy the hands to hold boxes 112.

In the illustrated example, user 102a makes a control gesture in the form of non-speech sounds 108a, “Sniff, Sniff, Sigh”. The non-speech sounds 108a are detected by microphones and/or sensors in the hearable device 104. The pattern of the non-speech sounds 108a is compared by the hearable device 104 to stored patterns of control gestures and found to match with a control gesture that correlates with a particular adjustment of a feature associated with the hearable device 104.

Prior to making the feature adjustment in this example, the hearable device 104 produces a feedback indicator 114 to user 102a in the form of audio inquiry output that describes the adjustment, “Do You Want To Pause Content?.” The control system 100 holds in making the feature adjustment while the system 100 receives a control gesture response 110, “Sniff”. The control system 100 determines that the control gesture response 110 indicates a positive response to the inquiry and proceeds to make the feature adjustment (e.g., pause playing of content).

In some implementations, the control gesture response 110 may be a simple non-speech sound, such as a single sound. Since the control system 100 scans for a particular response to the inquiry, a single sound may be recognizable as distinct. A sequence of audio is illustrated in FIG. 1 by reference numbers: 1 for the control gesture, 2 for the feedback indicator inquiry, and 3 for the control gesture response.

User 102b also makes non-speech sounds 108b, “Cluck, Cluck, Cluck.” The non-speech sounds 108b are detected by microphones and/or sensors in the hearable device 104. The pattern of repeating sounds of the non-speech sounds 108b is compared by the hearable device 104 to stored patterns of control gestures and found to match with a control gesture that correlates with a particular adjustment of a feature associated with the hearable device 104.

The control system 100 provides a feedback indicator that includes a tactile feedback 116 in the form of vibrating the cups of headphone device 104 that fit over the ears to inform the user 102b that the particular feature adjustment is about to take place, is taking place, or has taken place. In various implementations, the tactile feedback 116 may be output independently without other feedback indicators as an indicative of the feature adjustment. The tactile feedback 116 may also be output before an audio descriptive feedback indicator or during output of the audio descriptive feedback indicator as an extra alert to the user.

In some implementations, the control system may employ an artificial intelligence (AI) model to output a prediction that a detected pattern of non-speech sounds input into the AI model is the control gesture rather than a non-gesture sound. The AI model may be trained on various datasets including non-gesture sounds regularly made by the user, the control gestures that are typical for a group of sample users or for the subject user, and other datasets related to non-speech sound patterns that can be correlated to control gestures.

The control system may employ control gestures to adjust a feature relative to the environment of the user. FIGS. 2 and 3 show examples of the non-speech sound control system in which an area or source in a sound field in the environment of the user is indicated by non-speech sounds to adjust a feature onto a target area or source. Directing certain audio components of the hearable device onto a part or object(s) in the environment can facilitate reducing extraneous noises and enable a user to better hear a target sound source.

FIG. 2 illustrates one application of a gesture control system 200 for a user 202 to control size of a focus area in the environment for audio elements of the hearable device by using a control gesture. The focus area may include a sound source 204 that produces a sound that the user 202 intends to hear. The size of the focus area, e.g., width, can be varied by various patterns of non-speech sound. One or more features of the hearable device may be adjusted to be directed toward the initial focus area 206 according to the control gesture. Prior to the user making this feature adjustment, the focus area 206 may be defined as a space between imaginary dotted lines D, E, as an initial space of focus of certain audio elements of the hearable device.

The user performs non-speech sounds 212 that the gesture control system 200 identifies as a control gesture, such as repetitive sounds and combinations of different non-speech sounds. In the example provided by FIG. 2, the non-speech sound “Gasp” may indicate a user intent to control the focus area 206 and repetitive sounds “Smack, Smack” may indicate a command to narrow the focus area by two increments.

In some implementations, a number of a specific non-speech sound performed during a predefined time period may correlate with incremental narrowing or widening 208a, 208b of the focus area. The control gesture directs incremental adjustments 208a, 208b (illustrated by imaginary dotted arrow lines) of the features(s) to narrow the adjusted focus area 210 to fit proximal to the sound source object 204. In some implementations, a feedback indicator 214 may be outputted for each incremental change (illustrated as outputted twice) in the focus area to provide the user with information on the adjusted size of the focus area made in response to the control gestures.

A fitted focus area may facilitate enhanced hearing of sounds made by the object 204 (sound source) without potentially interfering noises elsewhere in the environment. In some implementations, the fitted focus area may be expanded to encompass a wider area of the environment in a similar manner as described in FIG. 2 for narrowing of the sound focus area, for example, to include a group of sound sources.

FIG. 3 shows an example of the gesture control system 300 that includes a hearable device 304 in which non-speech sound patterns of user 302 are used to control a feature by indicating a focus section of a sound view (auditory detection) or field of view (visual detection) of the control system 300.

The feature associated with the hearable device may be adjusted to be directed toward the indicated section of the field of view. For example, an audio beam forming feature may be adjusted by directing the focus of the hearable device toward the indicated section. In some implementations, the field of view may be divided into sections, such as quadrants 322a, 322b, 322c, and 322d, halves (322a-322b and 322c-322d), spaces made by other grid configurations, varied segment sizes or shapes, etc., to create sections of the sound field or field of view.

The control system 300 may determine that the non-speech sound 324, “Throat Clear” correlates with a focus area adjustment and non-speech sound 324. “Kiss” correlates with the upper left quadrant 322a (e.g., first quadrant) of the field of view 310. The field of view 310 is the space viewable by the user 302 and illustrated by imaginary dotted lines M, N, using horizontal spatial separation and/or vertical spatial separation.

In some implementations, the gesture control system may include additional wearable device(s) 306 to provide information, such as visual image data, to control features associated with the hearable device. The wearable device 306 may include a variety of sensor devices that include an outward facing image capture sensor (e.g., camera) directed toward the field of view 310. The wearable device 306 may capture images of object 314 in the field of view 310. In some implementations, an outward facing image capture sensor may be a separate component or may be integrated with the hearable device. The wearable device 306 may be in the form of glasses (including goggles), a headset, or other devices. The wearable device 306 is in communication with the hearable device 304 to exchange information regarding the field of view.

In some implementations, the control gesture may include predefined non-speech sounds specific for a particular object (i.e., target sound source), e.g., a person. For example, an important person to the user may be identified by a particular pattern of non-speech sound(s) and the wearable device with an outward facing image capture sensor may capture an image of the object. Upon detection of the direction of the indicated object, feature adjustments may be automatically made toward the indicated object.

The feature associated with the hearable device may be adjusted to be directed toward the indicated section of the field of view and/or target sound source. For example, an audio beam forming feature may be adjusted by directing the focus of the hearable device toward the indicated section 322a. In some implementations, the field of view may be divided into sections, such as quadrants, halves, or other grid configurations to create sections of the field of view.

Feedback may be provided as a notification to the user of the section of a sound field or target sound source determined by the control gesture. The feedback notification may inform the user of the direction that an audio beam focusing or other feature is directed. For example, an audio speech may be output through the speakers of the hearable device and state the identified section of the field of view, as illustrated by “upper left section focused” and/or the name of the person who is identified as a target sound source.

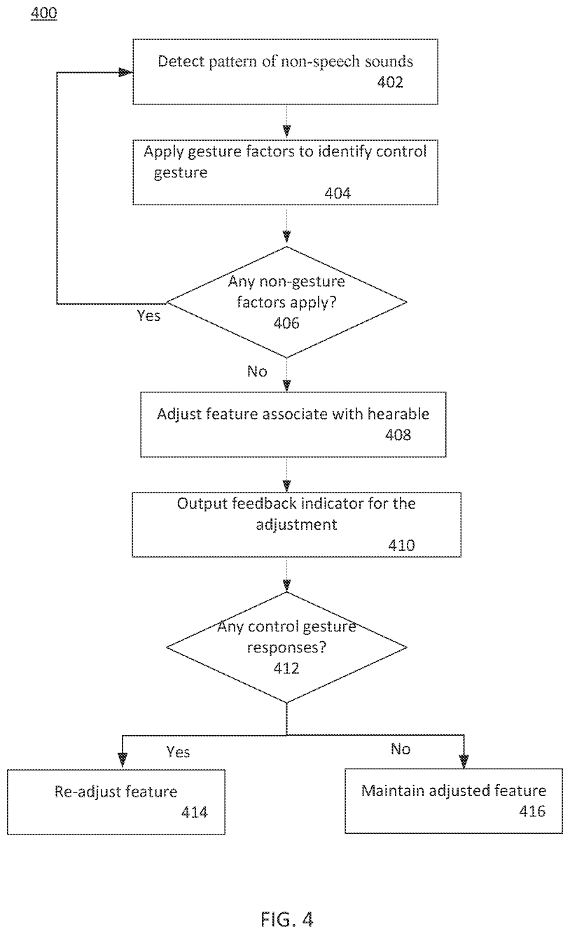

FIG. 4 shows a flow chart of a control gesture process 400 performed by the control system. In block 402, the system detects a pattern of non-speech sounds made by the user. Detection of the non-speech sound may be performed by analyzing data related to the non-speech sound from various microphones and/or sensors of the control system and/or from external sensors that communicate the data to the control system. Often, a plurality of microphones are dispersed in a component of the hearable device proximal to the ear(s), such as microphones positioned in cups of a hearable device, individual earbuds, and hearing aids. The microphones may be positioned vertically and/or horizontally offset from each other to enable vertical and/or horizontal special separation of sounds. In some implementations, the microphones may be positioned to detect sounds made by the user nose, tongue, lips, throat, and/or breath.

In some implementations, various sensors, such as vibration sensors, electrodes, etc., may be employed to detect the non-speech sounds made by the user. For example, sensors may detect bone conducted speech by sensing vibrations through skull bones, bones of the face, jaw vibrations, and/or soft tissue that correlate with non-speech sounds. Other mechanisms to detect non-speech sounds are possible, such as electrodes to detect electrical conductance, impedance, etc.

In block 404, a sound gesture is identified by applying sound factors that correlate with particular feature adjustments. Data characterizing the non-speech sounds are compared to the stored sound factors. When the sound factors are satisfied, the control gesture may be identified. However, such identification may be preliminary should the identification be rejected as a random non-speech sound according to decision block 406.

In some implementations, the sound gesture is identified by various other data in addition to applying sound factors. For example, particular user movements associated with a user head that satisfy gesture factors related to head control gestures may be employed along with non-speech sounds to identify a control gesture. Some examples of identifying control gestures based on user movements are described in U.S. Provisional Patent Application No. 63/571,967 entitled, “Head Gesture-Based Control With A Hearable Device,” filed Mar. 29, 2024, the contents of which are incorporated by reference herein.

In decision block 406, it is determined whether any non-gesture factors are satisfied by the non-speech sound. If the non-speech sound (preliminary control gesture) does not adequately satisfy non-gesture factors, the identification of the control gesture is confirmed, and the process proceeds to block 408 to adjust a feature described below. If, however, non-gesture factors are sufficiently satisfied, the non-speech sound is rejected, and the process returns to block 402 to scan for and detect further non-speech sounds. Non-gesture factors can indicate that indicate the non-speech sound is inadvertent rather than an intended control gesture.

Various context information may be gathered about the non-speech sound(s) to determine if non-gesture factors are satisfied, such as elements that relate to the environment of the user, user activity, other sounds by the user, other characteristics of the non-speech sound, etc. Non-gesture factors include considerations that can indicate the non-speech sound is not a control gesture, even if the non-speech sound satisfies some or all of the sound factors.

Non-gesture factors may include characteristics of the non-speech sound, such as interfering non-speech sound spoken by the user. For example, the user may make non-speech sounds while performing certain activities like eating, drinking, exercising, etc. Other non-gesture factors may relate to rate of the non-speech sound. A non-gesture factor may characterize a sound as slow and smooth or fast and sudden, such as during a sneeze, etc.

Non-gesture factors may also include body function sounds of the user detected by various sensors as accompanying the subject non-speech sound, such as arbitrary noises made by the user during a sneeze, cough, burp, and the like. Non-gesture factors may also include detection of body movement such as head movements that accompany the subject non-speech sounds, such as a jerk of the head during a sneeze, cough, burp, and the like. Some examples of detecting head movements are described in patent application No. 63/571,967 entitled, “Head Gesture-Based Control With A Hearable Device,” filed Mar. 29, 2024, the contents of which are incorporated by reference herein.

In some implementations, some non-gesture factors may be specific to user characteristics, a current activity of the user or environment of the user. For example, if the user is participating in an activity such as running that may result in inadvertent non-speech sounds, the control system may disregard the control gesture during the activity or disable the control gesture functionality all together during the activity. Similarly, if the user is in an environment that promotes inadvertent non-speech sounds, the non-speech sound may be rejected as a control gesture.

If the non-gesture factors are satisfied, the preliminary identified control gesture is rejected and the process returns back to block 404 to detect further non-speech sound. If the non-gesture factors are not satisfied the control gesture identification is confirmed and the process proceeds to block 410.

In block 408, the feature associated with the hearable device is adjusted as prescribed by the confirmed control gesture. In some implementations, the feature may include audio beam forming and the adjustment may include refocusing hearing enhancement components, such as filtering and/or amplification, of the hearable device.

In block 410, a feedback indicator is outputted to the user describing the feature adjustment. The feedback indicator includes a description of the type of feature being adjusted, the amount of adjustment and/or type of adjustment. The feedback indicator may be an audio speech describing the adjustment, rather than a non-descript and non-verbal sound, such as a beep.

Feedback may also include tactile notification, such as the vibration of one or more earpads or other hearable device component in contact with the skin of the user. Such feedback indicator may be coupled with an audio notification of the adjustment or be used as the only type of feedback to the user.

The feedback indicator may be outputted at various times in the control process, such as after the feature adjustment is identified as being correlated with a detected and identified (confirmed) control gesture. In this manner, the user may choose to override the adjustment before the feature adjustment is made. In some implementations, the feedback indicator may be output during the process of adjusting the feature. In still other implementations, the feedback indicator may be output immediately after the feature adjustment is completed. In this case, the user may opt to reverse the feature adjustment or make additional changes to the adjustment that has completed by making further control gestures.

In some implementations, the feedback is an audio identification of a recognized source selected from stored candidate sound sources. At least one of the microphones of the hearable device may receive sound signals for a sound made from a target sound source in the environment of the user. The gesture control system may compare the sound with stored sound prints. The stored sound prints are data previously stored sound snippets produced by candidate sound sources. For example, voiceprints of person(s) known as important to the user may be stored in a database accessible to the gesture control system. Other common sounds from objects are possible, such as the sound of a vehicle, animal, machine, etc. Some stored sounds may be context related, such as sounds associated with a particular environmental or user activity related, for example, a loudspeaker announcement. The sound signals may be matched to the sound print and the target sound source may be identified as a recognized source from the collection of candidate sound sources.

The user may provide a follow-up control gesture in response to receiving the feedback indicator. Such control gesture responses may be used to cancel the feature adjustment, such as if the adjustment was in error, to make further adjustments to the feature, such as increasing or decreasing a strength of the adjustment, or make additional adjustments to the feature or other features.

In some implementations, the feedback indicator may be in the form of an inquiry output to the user to elicit a response from the user. For example, the feedback indicator may state a description of an impending feature adjustment and request that the user confirm that the user intends the feature adjustment.

In decision block 412, the control system may scan for non-speech sounds and identify the sounds as a control gesture response to the feedback indicator. The control system may pause in making the adjustment as it scans for non-speech sound as an additional control gesture response, e.g., repeat the control gesture to confirm, make a single non-speech sound that conveys that the user intends the feature adjustment, etc. Once the control gesture response is received and identified using the above described methods to identify a control gesture, the control system may continue with the feature adjustment as in block 416 or abandon the adjustment or make corrective adjustments as in block 414, according to the control gesture response.

Other variations of the process described in FIG. 4 are possible. For example, in some implementations, block 406 identifying a control gesture and block 408 rejecting the gesture as random non-speech sound, may occur in reverse order. A non-speech sound may be determined to satisfy a non-gesture factor in block 408 and be disqualified before consideration as a control gesture in block 406.

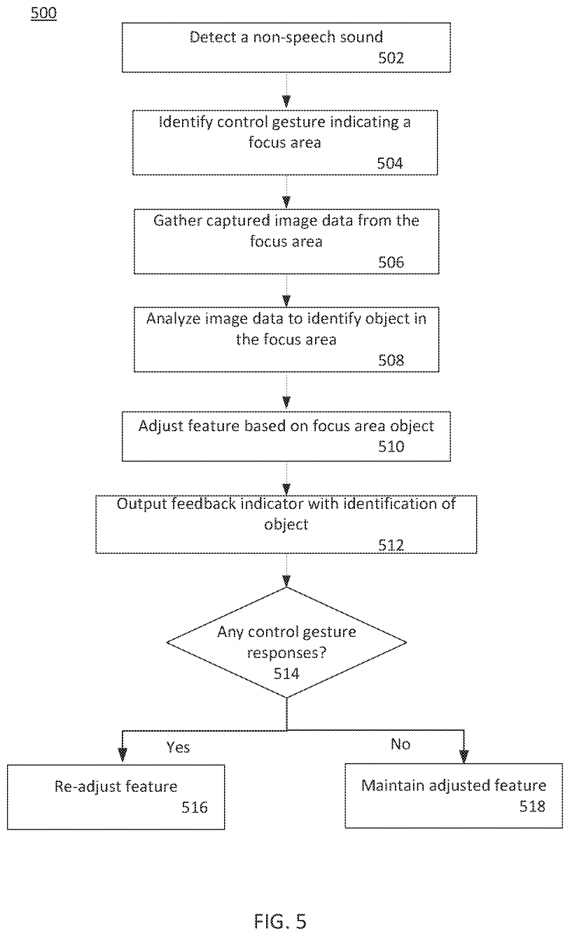

FIG. 5 shows a flow chart of a sound gesture process 500 to determine a focus area and object onto which to direct the feature adjustment. In block 502, non-speech sound is detected, as described above in item 402 of FIG. 4. In block 504, control gesture is identified, as described above in item 404 of FIG. 4.

In block 506, a focus area may be determined based, at least in part, on an analysis of the sound gesture that indicates a user intended focus area. For example, the user may make a particular non-speech sound that correlates with a section of a divided field of view or sound view in the environment.

In block 508, image data from the focus area may be analyzed to identify the object in the focus area. The image data may be received by an image capture device integrated with the hearable device, attached to the hearable device, or separate from and in communication with the hearable device.

In block 510, the feature associated with the hearable device is adjusted to be directed to the identified object in the focus area.

In block 512, a feedback indicator is outputted to describe the feature adjustment. In some implementations, the feedback indicator includes a description of the focus area. In still some implementations, the feedback indicator also or instead identifies the object. For example, the type of object may be described (e.g., animal, person, etc.) The identification may include a name or title for an object that is a person. Such identification may be stored in an index of control gestures that correlates with the identified control gesture.

In decision block 514, the control system may scan for non-speech sounds and identify the sounds as a control gesture response to the feedback indicator. Once the control gesture response is received and identified using the above described methods to identify a control gesture, the control system may continue with the feature adjustment as in block 518 or abandon the adjustment or make corrective adjustments as in block 516, according to the control gesture response.

The methods of FIGS. 4 and 5 described herein can be performed via software, hardware, and combinations thereof. The process may be carried out in software, such as one or more steps of the process carried out by the non-speech sound control system. Although the description has been described with respect to particular implementations thereof, these particular implementations are merely illustrative, and not restrictive.

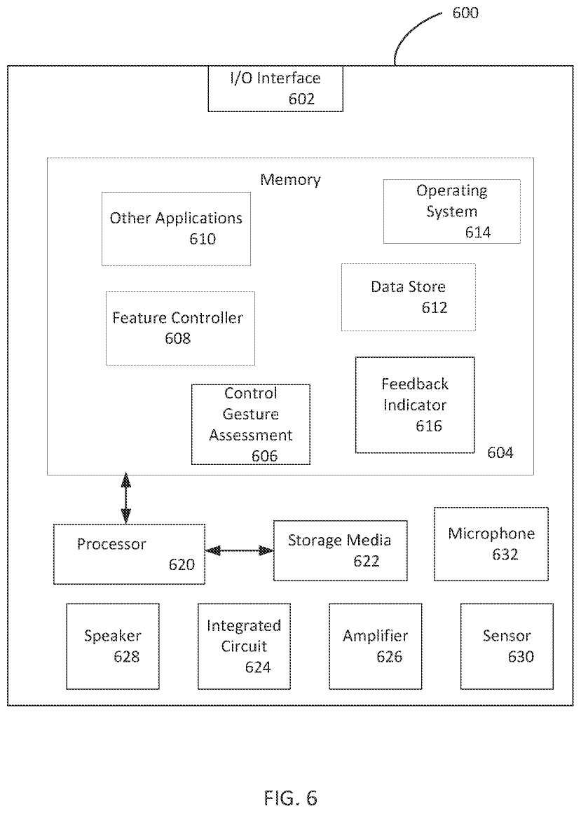

FIG. 6 is a block diagram illustrating some example functional electronic components of a hearable device of the gesture control system (also referred to as an apparatus) upon which aspects of the gesture control processes described herein may be implemented. The hearable device 600 is merely illustrative and not intended to limit the scope of the claims. One of ordinary skill in the art would recognize other variations, modifications, and alternatives. The components shown are illustrative of only some of the components of the hearable device, as other components typically present.

In one exemplary implementation, hearable device 600 includes an I/O interface 602 (which may represent a combination of a variety of communication interfaces). In some implementations, interface 602 may communicate with wearable device and/or image capture sensor(s) (such as item 306 and 510 in FIG. 3) to receive image information. The connection with the wearable device and/or image capture sensor may be wired, such as electrical cables, or wireless as described below. For example, wires may extend through stems of glasses to physically connect with the hearable device at the ears of the user. The interface 602 may also be enabled for wireless communication, such as via BLUETOOTH, BLUETOOTH Low Energy (BLE), radio frequency identification (RFID), etc. Wireless communication may be enabled to communicate with another earbud of a pair or hearing aid of a pair while being worn at the other ear of the user.

In some implementations, hearable device 600 may also include software that enables communications of I/O interface 602 over a network such as HTTP, TCP/IP, RTP/RTSP, protocols, wireless application protocol (WAP), IEEE 902.11 protocols, and the like. In addition to and/or alternatively, other communications software and transfer protocols may also be used, for example IPX, UDP or the like. The communication network may include a local area network, a wide area network, a wireless network, an Intranet, the Internet, a private network, a public network, a switched network, or any other suitable communication network, such as for example Cloud networks.

Other common hearable device components may include an integrated circuit 624 for controlling functions. A speaker 628 may be included to output sound, such as content being played, audio feedback indicator (e.g., speech) to the user from stored feedback snippets produced by feedback indicator module 616, etc. A computer chip-embedded amplifier 626 is provided to convert electrical signals from the microphones to digital signals. Other components may include a receiver for microphone(s) to receive sound input and various other known components.

Sensor(s) 630 may be provided to detect non-speech sound and/or collect related data such as image data of a focus area, head movement of the user, etc. Examples of sensor(s) 630 may include one or more cameras, one or more accelerometer (e.g., one-dimensional movement data relative to gravity), gyroscope (e.g., for rotational movement in combination with accelerometer data), magnetometer (e.g., movements relative to north pole), proximity detection (e.g., radar, lidar, infrared, etc.), and other sensors to detect or determine movement. Often a combination of sensors provide data used by control gesture assessment module 606 to determine control gestures.

Sensor(s) 630 may include a variety of sensors that enable detection of the non-speech sound. In some implementations, the sensor 630 may be a bone conduction sensor that relies on bone conduction to detect jaw vibrations that can occur when the user creates some non-speech sounds, such as the sound of “hmm”. The sound data from the sensor may be assessed to determine if the user creates a non-speech sound. The control gesture assessment module 606 may identify that the vibrations correspond to a particular pattern of non-speech sound that is identified as a control gesture.

Hearable device 600 typically includes additional familiar computer components such as a processor 620, and memory storage devices, such as a memory 604. A bus (not shown) may interconnect hearable device components. While a computer is shown, it will be readily apparent to one of ordinary skill in the art that many other hardware and software configurations are suitable for use with the present invention

The hearable device 600 may include a solid state memory in the form of NAND flash memory and storage media 622. The computer device may include a microSD card for storage and/or may also interface with cloud storage server(s). Memory 604 and storage media 622 are examples of tangible non-transitory computer readable media for storage of data, audio files, computer programs, and the like. Other types of tangible media include disk drives, solid-state drives, floppy disks, optical storage media and bar codes, semiconductor memories such as flash drives, flash memories, random-access or read-only types of memories, battery-backed volatile memories, networked storage devices, cloud storage, and the like. A data store 612 may be employed to store various on-board data such as a database of stored sound prints of candidate sound sources, database of sound factors that correspond to particular feature adjustments, database of non-gesture factors that correspond with random non-speech sound that are not control gestures, etc.

Hearable device 600 may include one or more computer programs, such as one or more software modules for control gesture assessment module 606, feature controller 608, feedback indicator module 616 and various other applications 610 to perform operations described herein. The control gesture assessment module module 606 performs one or more operations of assessing non-speech sound to determine control gestures by applying sound factors and/or non-gesture factors, such as described with regard to blocks 404 and 406 in FIG. 4. The feature controller 608 may control operations of adjusting features according to the determined control gesture, such as described with regards to block 408 in FIG. 4 and block 510 in FIG. 5. For example, adjustments may include changes in functionality of microphone(s) and processing of sound received by the microphone according to the direction of the target sound source. Beam forming feature controls may include adjusting filtering and/or amplification, such as via amplifier 626 of particular sounds to isolate the sound. Other methods of adjusting the focus of the hearable device, such as redirecting the direction of the microphones are possible.

Such computer programs, when executed by one or more processors, are operable to perform various tasks of using control gesture to adjust features associated with the hearable device, as in the methods described above. The computer programs may also be referred to as programs, software, software applications or code, may also contain instructions that, when executed, perform one or more methods, such as those described herein. The computer program may be tangibly embodied in an information carrier such as computer or machine readable medium, for example, the memory 604, storage device or memory on processor 620. A machine readable medium is any computer program product, apparatus or device used to provide machine instructions or data to a programmable processor.

Hearable device 600 further includes an operating system 614 to control and manage the hardware and software of the hearable device 600. Any operating system 614, e.g., mobile OS, that is supports the noise cancelation override methods may be employed, e.g., IOS, Android, Windows, MacOS, Chrome, Linux, etc.

Although the description has been described with respect to particular implementations thereof, these particular implementations are merely illustrative, and not restrictive.

Any suitable programming language can be used to implement the routines of particular embodiments including C, C++, Java, assembly language, etc. Different programming techniques can be employed such as procedural or object oriented. The routines can be executed on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for using a non-speech sound to control a feature associated with a hearable device, the method comprising:
detecting a first pattern of non-speech sounds by a user of the hearable device created by one or more of breath, nose, tongue, lips, and throat of the user;
identifying the first pattern of non-speech sound as a control gesture corresponding to a particular adjustment of the feature associated with the hearable device, by applying one or more sound factors;
based, at least in part, on identifying the control gesture, adjusting the feature according to the particular adjustment; and
outputting to the user, a feedback indicator to describe the adjusting of the feature.

2. The method of claim 1, further comprising:
receiving output from an artificial intelligence (AI) model trained, at least in part, on non-gesture sounds regularly made by the user and on the control gestures, to predict that the detected first pattern of non-speech sounds is the control gesture rather than a non-gesture sound.

3. The method of claim 1, wherein the control gesture includes a distinct pattern of breathing that is different from regular breathing patterns of the user, wherein the distinct pattern includes at least one variation in a particular rate of inhale and/or exhale and includes a predefined hold time after exhale and/or after inhale.

4. The method of claim 1, further comprising:
producing a tactile feedback by moving one or more hearable components proximal to a user ear, wherein the tactile feedback is associated with outputting of the feedback indicator.

5. The method of claim 1, wherein the feature includes audio beam focusing and wherein the feedback indicator includes a notification of a section of a sound field that the audio beam focusing is directed.

6. The method of claim 1, further comprising:
receiving a second pattern of non-speech sounds;
gathering context information associated with the second pattern of non-speech sounds;
applying one or more non-gesture sound factors to identify the second pattern of non-speech sounds as a non-gesture sound; and
rejecting the second pattern of non-speech sounds for control of the feature.

7. The method of claim 1, further comprising:
outputting an inquiry for user control;
detecting the first pattern of the non-speech sounds; and
determining the first pattern of non-speech sounds is responsive to the inquiry.

8. A sound gesture control system to adjust a feature associated with a hearable device, the sound gesture control system comprising:
at least one sensor to detect at least one non-speech sound of a user using the hearable device;
a hearable device of a user comprising:
one or more processors; and
logic encoded in one or more non-transitory media for execution by the one or more processors and when executed, operable to perform operations comprising:
detecting a first pattern of non-speech sounds by a user of the hearable device created by one or more of breath, nose, tongue, lips, and throat of the user;
identifying the first pattern of non-speech sounds as a control gesture corresponding to a particular adjustment of the feature associated with the hearable device, by applying one or more sound factors;
based, at least in part, on identifying the control gesture, adjusting the feature according to the particular adjustment, wherein the feature is selected from the group of: setting, mode, audio content player, audio beam focus, calling interaction, and smart assistant operation; and
outputting to the user, a feedback indicator to describe the adjusting of the feature.

9. The sound gesture control system of claim 8, wherein the operations further comprise:
receiving output from an artificial intelligence model trained, at least in part, on non-gesture sounds regularly made by the user and on the control gesture, to predict that the detected first pattern of non-speech sounds is the control gesture rather than a non-gesture sound.

10. The sound gesture control system of claim 8, wherein the control gesture includes a distinct pattern of breathing that is different from regular breathing patterns of the user, wherein the distinct pattern includes at least one variation in a particular rate of inhale and/or exhale and includes a predefined hold time after exhale and/or after inhale.

11. The sound gesture control system of claim 8, producing a tactile feedback by moving one or more hearable components proximal to a user ear, wherein the tactile feedback is associated with outputting of the feedback indicator.

12. The sound gesture control system of claim 8, wherein the feature includes audio beam focusing and wherein the feedback indicator includes a notification of a section of a sound field that the audio beam focusing is directed.

13. The sound gesture control system of claim 8, wherein the operations further comprise:
receiving a second pattern of non-speech sounds;
gathering context information associated with the second pattern of non-speech sounds;
applying one or more non-gesture sound factors to identify the second pattern of non-speech sounds as a non-gesture sound; and
rejecting the second pattern of non-speech sounds for control of the feature.

14. The sound gesture control system of claim 8, further comprises:
outputting an inquiry for user control;
detecting the first pattern of non-speech sounds; and
determining the first pattern of non-speech sounds is responsive to the inquiry.

15. A non-transitory computer-readable storage medium carrying program instructions thereon for using sound gesture to control a feature associated with a hearable device, the instructions when executed by one or more processors cause the one or more processors to perform operations comprising:
detecting first pattern of non-speech sounds by a user of the hearable device created by one or more of breath, nose, tongue, lips, and throat of the user;
identifying the first pattern of non-speech sounds as a control gesture corresponding to a particular adjustment of the feature associated with the hearable device, by applying one or more sound factors;
based, at least in part, on identifying the control gesture, adjusting the feature according to the particular adjustment, wherein the feature is selected from the group of: setting, mode, audio content player, audio beam focus, calling interaction, and smart assistant operation; and
outputting to the user, a feedback indicator to describe the adjusting of the feature.

16. The non-transitory computer-readable storage medium of claim 15, wherein the operations further comprise:
receiving output from an artificial intelligence model trained, at least in part, on non-gesture sounds regularly made by the user and on the control gesture, to predict that the detected first pattern of non-speech sounds is the control gesture rather than a non-gesture sound.

17. The non-transitory computer-readable storage medium of claim 16, wherein the control gesture includes a distinct pattern of breathing that is different from regular breathing patterns of the user, wherein the distinct pattern includes at least one variation in a particular rate of inhale and/or exhale and includes a predefined hold time after exhale and/or after inhale.

18. The non-transitory computer-readable storage medium of claim 15, wherein the feature includes audio beam focusing and wherein the feedback indicator includes a notification of a section of a sound field that the audio beam focusing is directed.

19. The non-transitory computer-readable storage medium of claim 15, wherein the operations further comprise:
receiving a second pattern of non-speech sounds;
gathering context information associated with the second pattern of non-speech sounds;
applying one or more non-gesture sound factors to identify the second pattern of non-speech sounds as a non-gesture sound; and
rejecting the second pattern of non-speech sounds for control of the feature.

20. The non-transitory computer-readable storage medium of claim 15, wherein operations further comprise:
outputting an inquiry for user control;
detecting the first pattern of non-speech sounds; and
determining the first pattern of non-speech sounds is responsive to the inquiry.
